(19) United States
(12) Patent Application Publication
(10) Pub. No.: US 2013/0197137 A1
(43) Pub. Date: Aug. 1, 2013

(54) PROCESS FOR PREPARING HIGH-PURITY ORGANICALLY MODIFIED PHYLLOSILICATES

(71) Applicants: Jochen Norwig, Leverkusen (DE); Ralf Spiale, Leverkusen (DE); Wolfgang Assmuth, Bergisch (DE); Holger Egger, Koln (DE)

(72) Inventors: Jochen Norwig, Leverkusen (DE); Ralf Spiale, Leverkusen (DE); Wolfgang Assmuth, Bergisch (DE); Holger Egger, Koln (DE)

(73) Assignee: BAYER INTELLECTUAL PROPERTY GMBH, Monheim (DE)

(21) Appl. No.: 13/809,126

(22) PCT Filed: Jul. 8, 2011
(86) PCT No.: PCT/EP2011/061669

§ 371 Date: Mar. 21, 2013

(30) Foreign Application Priority Data
Jul. 12, 2010 (EP) 10169272.1

(51) Int. Cl. C08K 5/544

(52) U.S. Cl. CPC C08K 5/544
USPC 524/188; 106/287.1

(57) ABSTRACT

The present invention relates to a novel process for preparing organically modified sheet silicates in high purity. The process of the invention uses ion exchange resins for this purpose.

The present invention relates to a novel process for preparing organically modified sheet silicates in high purity. The process of the invention uses ion exchange resins for this purpose.

Sheet silicates or clay minerals are a subgroup of the silicate minerals. In sheet silicates there are, inter alia, SiO₄ tetrahedra crosslinked to form layers having the composition Si₂O₅.

Furthermore, these layers of tetrahedra in the abovementioned sheet silicates alternate with layers of octahedra. In these layers of octahedra cations are surrounded by hydroxide ions and/or oxygen in an octahedral arrangement. Such cations are usually the positively charged ions of aluminium and/or of magnesium. The abovementioned layers are the reason for the designation as sheet silicates in contrast to other silicates.

A distinction is usually made between two-sheet silicates, for example kaolinite or serpentine, and three-sheet silicates, for example montmorillonite or mica. In two-sheet silicates, a layer of tetrahedra is in each case joined to a layer of octahedra, and in three-sheet silicates a layer of octahedra is joined to two layers of tetrahedra.

The abovementioned layers form two-dimensional structures which are held together by electrostatic interactions in the sheet silicate. The actual layers are themselves mostly partially negatively charged and the charges are balanced by cations in the intermediate spaces between the respective layers. These cations are distinct from the abovementioned cations in the layers of octahedra. Many sheet silicates can be readily swollen and dispersed in water. This process is also referred to as exfoliation.

The cations in the intermediate spaces between the respective layers are not firmly bound into the structure of the sheet silicates and can therefore be replaced, for example, by other positively charged compounds, so that the surfaces, in particular, of the sheet silicates can be comparatively easily modified by means of organic compounds if these have a positive charge. The cations in the intermediate spaces between the respective layers are usually positively charged ions of sodium. The number of exchangeable cations in the intermediate spaces between the respective layers is indicated by the cation exchange capacity (abbreviated to: CEC; cf. G. Lagaly, chapter 3.1 “Ionenaustausch” in “Tonminerale and Tone”, edited by K. Jasmund, G. Lagaly, Steinkopff Verlag Darmstag, 1993, ISBN 3-7985-0923-9). This parameter is not a constant and can vary from sheet silicate type to sheet silicate type. The CEC is usually reported in meq of charge per g of sheet silicate.

Trimethylalkylammonium compounds are frequently used as other positively charged compounds which replace the cations in the intermediate spaces between the respective layers and thus modify the sheet silicate.

The use of trimethylalkylammonium compounds for replacing the cations in the intermediate spaces between the respective layers produces distinctly more hydrophobic sheet silicates. The thus organically modified sheet silicates can, with suitable choice of the alkyl of the trimethylalkylammonium compound, also be made compatible with organic media in which they could normally be dispersed only with difficulty because of their hydrophilic properties.

Such appropriately organically modified sheet silicates are often dispersed as fillers in polymers in order to, for example, give the latter increased mechanical strength, to increase the barrier properties in respect of gas or chemicals or to improve the flame resistance of the polymers. An improvement in a plurality of properties of the polymer can also frequently be achieved simultaneously.

The processes usually employed in the prior art for preparing organically modified sheet silicates are characterized in that the sheet silicate material to be modified is dispersed in an aqueous solution and the organic, positively charged compound by means of which the sheet silicate is to be modified is subsequently added. The organic, positively charged compound by means of which the sheet silicate is to be modified then adsorbs on the surface of the sheet silicate until all charges are balanced, which is generally awaited. The resulting suspension of the then organically modified sheet silicate is then usually purified, dried and processed further as a solid.

Such a process is described by, for example, Muh S. Wang and Thomas J. Pinnavaia in “Clay-Polymer Nanocomposites Formed from Acidic Derivatives of Montmorillonite and an Epoxy Resin” (Chem. Mat. 1994 (6), 468-474). Here, Na⁺-montmorillonite as sheet silicate is modified by means of various positively charged organic compounds including, for example, protonated aminocarboxylic acids, primary diamines and primary amines As described above, a solution of the abovementioned materials is always produced and the sheet silicate is dispersed in this solution. After replacement of the cations in the sheet silicate by the abovementioned materials, the dispersion is centrifuged and washed a number of times with deionized water before being dried by freeze drying and subsequently used further in an epoxy resin.

A disadvantage of this process, like the other known processes for preparing organically modified sheet silicates, is the fact that these in each case comprise one or usually even more purification steps. In the abovementioned case, this comprises multiple washing of the organically modified sheet silicates with deionized water.

This mode of operation has become generally established in the prior art because the organically modified sheet silicates later to be used in the polymers should be largely free of impurities, in particular the cations which were formerly present in the intermediate spaces between the layers of the sheet silicates and residues of positively charged organic compounds and their counterions.

Such impurities lead to many possible undesirable effects in the polymers into which the organically modified sheet silicates are to be introduced later. Thus, these impurities can induce or catalyse chemical degradation of the polymer, possibly make otherwise transparent polymers cloudy and reduce the chemical and/or mechanical stability of the polymer. This list can be continued at will, depending on the properties and the chemical composition of the polymer.

It is accordingly a requirement for the later use of the organically modified sheet silicates that they be as pure as possible. As indicated above, this is achieved in the prior art by means of a plurality of more or less complicated purification steps after the preparation of the organically modified sheet silicates. This is a disadvantage because it makes the organically modified sheet silicate comparatively expensive to prepare, if for no other reason. The purification by multiple washing with deionized and/or distilled water is, inter alia, harmful to the environment since the production of deionized and/or distilled water requires a considerable input of energy and the washing water then frequently has to be disposed of as chemical waste, but at least has to be treated separately.

In the light of the abovementioned disadvantages of the prior art, it is therefore an object of the invention to provide a very simple process for preparing organically modified sheet silicates, in which subsequent purification of the sheet silicate after they have been organically modified can be dispensed with.

It has now surprisingly been found that a process for preparing organically modified sheet silicates by dispersing sheet silicates in a solvent comprising at least one organic molecule having at least a single positive charge, characterized in that particles of an ion exchange resin are also dispersed in the abovementioned solvent, is able to achieve this object.

The process of the invention is particularly advantageous because the further presence of the abovementioned particles of an ion exchange resin results in the otherwise dissolved positive ions (cations) which are present in/on the sheet silicates before the reaction being virtually quantitatively replaced by hydrogen ions when a cation exchange resin is used and the negatively charged ions (anions) which are present as counterions in the organic molecules having at least one positive charge being quantitatively replaced by hydroxide ions when an anion exchange resin is used, with these cations and/or anions then being bound in the ion exchange resin. Additional washing steps are therefore dispensed with. The hydrogen ions and hydroxide ions cause no harm and are, in particular, automatically concomitantly removed in the course of a possible later drying step. Usually, a plurality of the abovementioned hydrogen ions and hydroxide ions combine according to the generally known autoprotolysis law of water to form water.

In a preferred embodiment of the present invention, particles of an ion exchange resin which has both a cation exchange function and an anion exchange function are therefore used. Such ion exchange resins, which will hereinafter be referred to as “bifunctional ion exchange resins”, make it possible, in combination with the process of the invention, to achieve a particularly simple purification because, firstly, the abovementioned ions are, in a preferred embodiment, replaced directly by water (or its constituents hydroxide and hydrogen ions) which can be separated off without risk of encrustations or further residues as a result of the presence of the ion exchange resin in the reaction in the reaction mixture and, secondly, because any isolation of the organically modified sheet silicate can be carried out in a simple way by filtration of the loaded particles of the ion exchange resin.

In a particularly preferred embodiment of the present invention, particles of bifunctional ion exchange resins which are already present in the reaction of the organic molecules having at least one positive charge with the sheet silicates are used.

Further purification steps, whether before the modification or afterwards, can thus be dispensed with and modified sheet silicates which are free of anions and cations or salts formed therefrom are obtained by simple filtration.

In a particularly preferred embodiment of the present invention, particles of bifunctional ion exchange resins are used; the unmodified sheet silicates and the organic molecules having at least a positive charge are provided in separate solutions/dispersions, mixed with one another and the bifunctional ion exchange resin is added to the resulting solution immediately after mixing or during mixing, so that the ion exchange resin is present at the beginning of the reaction.

This mode of operation is particularly advantageous because it firstly makes the abovementioned simplified purification possible and at the same time prevents the bifunctional ion exchange resin from binding significant proportions of the organic molecules having at least one positive charge to its Lewis base function. An increased yield is thus achieved together with simplified purification.

For the purposes of the present invention, sheet silicates are all clay minerals which are made up of layers of [M(O,OH)₆] octahedra which are each condensed with one or two layers of [SiO₄] tetrahedra. Here, M denotes ions of metals of the Periodic Table of the Elements. Ions of the metals are preferably selected from the list consisting of the metals of main group two of the Periodic Table of the Elements, metals having the atomic number 13 and from 22 to 30 in the Periodic Table of the Elements and silicon.

Preferred sheet silicates are those selected from the list consisting of serpentines, kaolins, talc, pyrophyllites, smectites, vermiculites, illites, mica and brittle mica. Particularly preferred are those selected from the list consisting of talc, pyrophyllites, smectites, vermiculites, illites, mica and brittle mica. Very particular preference is given to smectites. Smectites also include the montmorillonites which are especially preferred sheet silicates for the purposes of the present invention.

For the purposes of the present invention, dispersion of the sheet silicates according to the invention in a solvent is the very fine dispersion of the sheet silicates, with the sheet silicates preferably being completely exfoliated. Dispersion is usually effected by stirring, shaking, ultrasonic treatment, wet milling or by means of other suitable mechanical apparatuses as are generally known to those skilled in the art.

In the context of the present invention, a solvent is any aqueous or organic medium. This means that solvents which can be used for the purposes of the present invention are, for example, the organic solvents which are generally known to those skilled in the art and water, ionic liquids and also any mixtures of these and/or solutions of these.

Solvents which are preferred for the purposes of the present invention are water and ionic liquids.

Particular preference is given here to ionic liquids which are in the liquid state under ambient conditions (1013 hPa, 23° C.) and in which the cation is organic.

Such organic liquids are, due to their nature as salts in the liquid state, particularly advantageous because they serve as solvent but at the same time also comprise, with the abovementioned organic cation comprise an organic molecule which has at least a single positive charge and can be used for modifying the sheet silicates.

Nonlimiting examples of ionic liquids which can advantageously be used for the purposes of the present invention are those having a cation as is disclosed below in connection with the organic molecules having at least a single positive charge as member of the group of pyridinium and imidazolium ions. Such ionic liquids usually have a halogen anion.

The use of water as solvent is likewise advantageous because water can be purified in a simple and generally known way, for instance by means of distillation and/or membrane separation processes, and recirculated to the process.

The proportion of sheet silicate in the solvent in the process of the invention can be in the range from 0.1 to 50% by weight, preferably in the range from 1 to 20% by weight, particularly preferably in the range from 5 to 10% by weight.

Organic molecules having at least a single positive charge are preferably those organic molecules which are at least singly positively charged at a pH of less than or equal to 4. Preference is accordingly given to the process of the invention being carried out in solvents having a pH of less than or equal to 4.

The abovementioned organic molecules having at least one positive charge always have negatively charged counterions such as halogen ions (e.g. Cl⁻, Br⁻, I⁻), (hydrogen)phosphate ions (e.g. HPO₄²⁻, PO₄³⁻) in such a number that the salt formed thereby or the ionic liquid of the organic molecule having at least one positive charge is charge neutral.

This can be achieved by acidifying the solvent with hydrochloric acid. How this can be achieved is generally known to those skilled in the art. At the same time, alternatives to hydrochloric acid by means of which this can be achieved, depending on the respective solvent, are also known to those skilled in the art.

Particular preference is given to organic molecules which have at least a single positive charge and in which the positive charge is due to at least one quaternary ammonium group.

Such materials, also referred to as alkylammonium compounds, are usually those of the general formula (N R¹R²,R³,R⁴)⁺, where

R¹, R², R³ and R⁴ are each, independently of one another, C₁-C₁₈-alkyl, C₂-C₁₈-alkyl which is optionally substituted by one or more oxygen atoms, e.g. 1-10 ethylene oxide units, C₆-C₁₂-aryl, C₅-C₁₂-cycloalkyl, where the radicals mentioned may each be substituted by functional groups, aryl, alkyl, aryloxy, alkyloxy, halogen, heteroatoms and/or heterocycles and/or bear 1-4 double bonds.

R¹, R², R³ and R⁴ can additionally be hydrogen.

R¹, R², R³ and R⁴ can also be C₁-C₁₈-alkyloyl (alkylcarbonyl), C₁-C₁₈-alkyloxycarbonyl, C₅-C₁₂-cycloalkylcarbonyl or C₆-C₁₂-aryloyl (arylcarbonyl), where the radicals mentioned may each be substituted by functional groups, aryl, alkyl, aryloxy, alkyloxy, halogen, heteroatoms and/or heterocycles.

C₁-C₁₈-alkyl which is optionally substituted by functional groups, aryl, alkyl, aryloxy, alkyloxy, halogen, heteroatoms and/or heterocycles is, for example, methyl, ethyl, propyl, isopropyl, n-butyl, sec-butyl, tert-butyl, pentyl, hexyl, heptyl, octyl, 2-ethylhexyl, 2,4,4-trimethylpentyl, decyl, dodecyl, tetradecyl, heptadecyl, octadecyl, 1,1-dimethylpropyl, 1,1-dimethylbutyl, 1,1,3,3-tetramethylbutyl, benzyl, 1-phenylethyl, 2-phenylethyl, α,α-dimethylbenzyl, benzhydryl, p-toluylmethyl, 1-(p-butylphenyl)ethyl, p-chlorobenzyl, 2,4-dichlorobenzyl, p-methoxybenzyl, m-ethoxybenzyl, 2-cyanoethyl, 2-cyanopropyl, 2-methoxycarbonethyl, 2-ethoxycarbonylethyl, 2-butoxycarbonylpropyl, 1,2-di(methoxycarbonyl)ethyl, 2-methoxyethyl, 2-ethoxyethyl, 2-butoxyethyl, diethoxymethyl, diethoxyethyl, 1,3-dioxan-2-yl, 2-methyl-1,3-dioxolan-2-yl, 4-methyl-1,3-dioxolan-2-yl, 2-isopropoxyethyl, 2-butoxypropyl, 2-octyloxyethyl, chloromethyl, 2-chloroethyl, trichloromethyl, trifluoromethyl, 1,1-dimethyl-2-chloroethyl, 2-methoxyisopropyl, 2-ethoxyethyl, butylthiomethyl, 2-dodecylthioethyl, 2-phenylthioethyl, 2,2,2-trifluoroethyl, 2-hydroxyethyl, 2-hydroxypropyl, 3-hydroxypropyl, 4-hydroxybutyl, 6-hydroxyhexyl, 2-aminoethyl, 2-aminopropyl, 3-aminopropyl, 4-aminobutyl, 6-aminohexyl, 2-methylaminoethyl, 2-methylaminopropyl, 3-methylaminopropyl, 4-methylaminobutyl, 6-methylaminohexyl, 2-dimethylaminoethyl, 2-dimethylaminopropyl, 3-dimethylaminopropyl, 4-dimethylaminobutyl, 6-dimethylaminohexyl, 2-hydroxy-2,2-dimethylethyl, 2-phenoxyethyl, 2-phenoxypropyl, 3-phenoxypropyl, 4-phenoxybutyl, 6-phenoxyhexyl, 2-methoxyethyl, 2-methoxypropyl, 3-methoxypropyl, 4-methoxybutyl, 6-methoxyhexyl, 2-ethoxyethyl, 2-ethoxypropyl, 3-ethoxypropyl, 4-ethoxybutyl or 6-ethoxyhexyl and

C₂-C₁₈-alkyl which is optionally interrupted by one or more oxygen atoms is, for example, 5-hydroxy-3-oxapentyl, 8-hydroxy-3,6-dioxaoctyl, 11-hydroxy-3,6,9-trioxaundecyl, 7-hydroxy-4-oxaheptyl, 11-hydroxy-4,8-dioxaundecyl, 15-hydroxy-4,8,12-trioxapentadecyl, 9-hydroxy-5-oxanonyl, 14-hydroxy-5,10-oxatetradecyl, 5-methoxy-3-oxapentyl, 8-methoxy-3,6-dioxaoctyl, 11-methoxy-3,6,9-trioxaundecyl, 7-methoxy-4-oxaheptyl, 11-methoxy-4,8-dioxaundecyl, 15-methoxy-4,8,12-trioxapentadecyl, 9-methoxy-5-oxanonyl, 14-methoxy-5,10-oxatetradecyl, 5-ethoxy-3-oxapentyl, 8-ethoxy-3,6-dioxaoctyl, 11-ethoxy-3,6,9-trioxaundecyl, 7-ethoxy-4-oxaheptyl, 11-ethoxy-4,8-dioxaundecyl, 15-ethoxy-4,8,12-trioxapentadecyl, 9-ethoxy-5-oxanonyl or 14-ethoxy-5,10-oxatetradecyl and

functional groups are, for example, carboxy, carboxamide, hydroxy, di(C₁-C₄-alkyl)amino, C₁-C₄-alkyloxycarbonyl, cyano or C₁-C₄-alkyloxy and

C₆-C₁₂-aryl which is optionally substituted by functional groups, aryl, alkyl, aryloxy, alkyloxy, halogen, heteroatoms and/or heterocycles is, for example, phenyl, toluyl, xylyl, α-naphthyl, β-naphthyl, 4-diphenylyl, chlorophenyl, dichlorophenyl, trichlorophenyl, difluorophenyl, methylphenyl, dimethylphenyl, trimethylphenyl, ethylphenyl, diethylphenyl, isopropylphenyl, tert-butylphenyl, dodecylphenyl, methoxyphenyl, dimethoxyphenyl, ethoxyphenyl, hexyloxyphenyl, methylnaphthyl, isopropylnaphthyl, chloronaphthyl, ethoxynaphthyl, 2,6-dimethylphenyl, 2,4,6-trimethylphenyl, 2,6-dimethoxyphenyl, 2,6-dichlorophenyl, 4-bromophenyl, 2- or 4-nitrophenyl, 2,4- or 2,6-dinitrophenyl, 4-dimethylaminophenyl, 4-acetylphenyl, methoxyethylphenyl or ethoxymethylphenyl and

C₅-C₁₂-cycloalkyl which is optionally substituted by functional groups, aryl, alkyl, aryloxy, alkyloxy, halogen, heteroatoms and/or heterocycles is, for example, cyclopentyl, cyclohexyl, cyclooctyl, cyclododecyl, methylcyclopentyl, dimethylcyclopentyl, methylcyclohexyl, dimethylcyclohexyl, diethylcyclohexyl, butylcyclohexyl, methoxycyclohexyl, dimethoxycyclohexyl, diethoxycyclohexyl, butylthiocyclohexyl, chlorocyclohexyl, dichlorocyclohexyl, dichlorocyclopentyl and also a saturated or unsaturated bicyclic system such as norbornyl or norbornenyl and

C₁-C₄-alkyl is, for example, methyl, ethyl, propyl, isopropyl, n-butyl, sec-butyl or tert-butyl and

C₁-C₁₈-alkyloyl (alkylcarbonyl) is, for example, acetyl, propionyl, n-butyloyl, sec-butyloyl, tert-butyloyl, 2-ethylhexylcarbonyl, decanoyl, dodecanoyl, chloroacetyl, trichloroacetyl or trifluoroacetyl and

C₁-C₁₈-alkyloxycarbonyl is, for example, methyloxycarbonyl, ethyloxycarbonyl, propyloxycarbonyl, isopropyloxycarbonyl, n-butyloxycarbonyl, sec-butyloxycarbonyl, tert-butyloxycarbonyl, hexyloxycarbonyl, 2-ethylhexyloxycarbonyl or benzyloxycarbonyl and

C₅-C₁₂-cycloalkylcarbonyl is, for example, cyclopentylcarbonyl, cyclohexylcarbonyl or cyclododecylcarbonyl and

C₆-C₁₂-aryloyl (arylcarbonyl) is, for example, benzoyl, toluyl, xyloyl, α-naphthoyl, β-naphthoyl, chlorobenzoyl, dichlorobenzoyl, trichlorobenzoyl or trimethylbenzoyl.

Preference is given to R¹, R², R³ and R⁴ each being, independently of one another, hydrogen, methyl, ethyl, n-butyl, 2-hydroxyethyl, 2-cyanoethyl, 2-(methoxycarbonyl)ethyl, 2-(ethoxycarbonyl)ethyl, 2-(n-butoxycarbonyl)ethyl, dimethylamino, diethylamino or chlorine.

R⁴ is preferably methyl, ethyl, n-butyl, 2-hydroxyethyl, 2-cyanoethyl, 2-(methoxycarbonyl)ethyl, 2-(ethoxycarbonyl)ethyl, 2-(n-butoxycarbonyl)ethyl, acetyl, propionyl, t-butyryl, methoxycarbonyl, ethoxycarbonyl or n-butoxycarbonyl.

Particular preference is likewise given to organic molecules having at least a single positive charge and in which the positive charge is due to at least one phosphonium group.

Such molecules are usually those of the general formula (P R¹R²,R³,R⁴)⁺, where, independently of one another,

R⁴ is acetyl, methyl, ethyl or n-butyl and

R¹, R² and R³ are each phenyl, phenoxy, ethoxy or n-butoxy.

Particular preference is likewise given to organic molecules having at least a single positive charge and in which the positive charge is present in a heterocyclic compound.

Among these heterocyclic compounds, preference is given to pyridinium or imidazolium ions.

Particular preference is given to pyridinium and imidazolium ions selected from the list consisting of 1,2-dimethylpyridinium, 1-methyl-2-ethylpyridinium, 1-methyl-2-ethyl-6-methylpyridinium, N-methylpyridinium, 1-butyl-2-methylpyridinium, 1-butyl-2-ethylpyridinium, 1-butyl-2-ethyl-6-methylpyridinium, n-butylpyridinium, 1-butyl-4-methylpyridinium, 1,3-dimethylimidazolium, 1,2,3-trimethylimidazolium, 1-n-butyl-3-methylimidazolium, 1,3,4,5-tetramethylimidazolium, 1,3,4-trimethylimidazolium, 2,3-dimethylimidazolium, 1-butyl-2,3-dimethylimidazolium, 3,4-dimethylimidazolium, 2-ethyl-3,4-dimethylimidazolium, 3-methyl-2-ethylimidazol, 3-butyl-1-methylimidazolium, 3-butyl-1-ethylimidazolium, 3-butyl-1,2-dimethylimidazolium, 1,3-di-n-butylimidazolium, 3-butyl-1,4,5-trimethylimidazolium, 3-butyl-1,4-dimethylimidazolium, 3-butyl-2-methylimidazolium, 1,3-dibutyl-2-methylimidazolium, 3-butyl-4-methylimidazolium, 3-butyl-2-ethyl-4-methylimidazolium and 3-butyl-2-ethylimidazolium, 1-methyl-3-octylimidazolium, 1-decyl-3-methylimidazolium.

The abovementioned heterocyclic compounds together with halogen anions are the above-described ionic liquids which can preferably be used in the process of the invention.

Very particular preference is given to organic molecules which have at least a single positive charge and in which the positive charge is due to at least one quaternary ammonium group and in which R¹ to R⁴ is in each case C₁-C₁₈-alkyl.

The organic molecules having at least a single positive charge are usually added in a CEC ratio in the range from 0.2 to 1.5 meq/g, preferably in the range from 0.5 to 1.2 meq/g, particularly preferably in the range from 0.95 to 1.05 meq/g.

In preferred embodiments of the process of the invention, the amount of added organic molecules having at least a single positive charge should, however, be in the approximate region of the CEC for purely economic reasons.

It is accordingly also possible for the process of the invention to be carried out with organic molecules having at least a single positive charge being added in amounts significantly below the CEC when only partial modification of the sheet silicate is to be carried out. In any case, the addition of the ion exchange resins also prevents the ions dissolved out of the sheet silicates in this way from contaminating the future process product.

However, the ratio of sheet silicate to organic molecules having at least a single positive charge is surprisingly inconsequential within the abovementioned ranges in the process of the invention. As a result of the presence of the ion exchange resin, all excess ions are advantageously removed again.

For the purposes of the present invention, ion exchange resins are polymeric materials which are able to exchange cations and/or anions for protons (H⁺) and/or hydroxide ions (OH⁻). If the ion exchange resins are able to exchange both cations and anions, these are referred to as bifunctional ion exchange resins for the purposes of the present invention.

As described above, a process using such bifunctional ion exchange resins is preferred.

Such bifunctional ion exchange resins can, in connection with the present invention, either be obtained by mixing particles of a cation exchange resin and an anion exchange resin, or the particles consist of a copolymer which contains blocks for the exchange of anions and blocks for the exchange of cations. Such a bifunctional ion exchange resin having blocks for the exchange of anions and cations thus has blocks which are a Lewis acid for the exchange of anions and blocks which are a Lewis base for the exchange of cations.

Even though the present invention relates to the use of ion exchange resins according to the above definition, other generally known ion exchange materials, e.g. zeolites, can also be used as ion exchangers and thus as substitute for ion exchange resins.

In the context of the present invention, the term ion exchange resin accordingly also encompasses nonpolymeric ion exchangers. Such other ion exchange materials, e.g. the abovementioned zeolites, can also be used in mixtures of particles having an anion exchange capability and a cation exchange capability in order to obtain bifunctional ion exchange resins as mentioned above.

According to the invention, the ion exchange resins are present as particles, which is particularly advantageous because these can easily be separated off again by, for instance, a filtration step which is likewise preferably carried out after the process of the invention.

The dispersing of the particles of the ion exchange resin according to the invention can be carried out together with the dispersing of the sheet silicates in the solvent or at a different time. Furthermore, the dispersing of the particles of the ion exchange resin in the solvent can be carried out with addition of the particles of the ion exchange resin in portions or addition of all the particles of the ion exchange resin at once.

In order to achieve particularly simple separation of the ion exchange resins from the solvent and from the then organically modified silicate materials, it is likewise preferred, in the process of the invention, for the average particle size of the sheet silicates and the average particle size of the ion exchange resins to differ by a factor of at least 10.

Since the organically modified sheet silicates usually have an average particle size in the range below 5 μm, particular preference is given to the particles of the ion exchange resins having an average particle size of more than 50 μm, very particularly preferably more than 150 μm, particularly preferably more than 400 μm.

The process of the invention is usually carried out at a temperature above room temperature (23° C.), preferably at temperatures in the range from 30° C. to 95° C., particularly preferably in the range from 60° C. to 90° C.

Furthermore, the process is usually carried out batchwise for a time in the range from 6 to 24 hours.

Within the abovementioned periods of time, a complete modification of the sheet silicates and a likewise completed exchange by means of the ion exchange resins can usually be assumed at the abovementioned temperatures.

The process of the invention is particularly advantageous when the ion exchange resin is regenerated in a further process step which is preferably carried out after the process of the invention and after the ion exchange resin has been separated off. This gives a mode of operation which is particularly sparing of resources.

The modified sheet silicates obtained by means of the process of the invention and its preferred variants are characterized by a particularly high purity, in particular freedom from ions, and are accordingly particularly well suited for incorporation into polymers since these polymers do not lose their positive properties in the absence of the abovementioned impurities.

In a preferred embodiment of the process of the invention, the preparation of the organically modified sheet silicates by dispersing of sheet silicates in a solvent comprising at least one organic molecule having at least a single positive charge in the presence of an ion exchange resin is accordingly followed by a drying step and this is followed by a further step in which the organically modified sheet silicates which have been dried in this way are incorporated into a polymer.

The incorporation of the organically modified sheet silicates into the polymer is carried out by means of the methods which are generally known to those skilled in the art. Nonlimiting examples of such generally known methods are, for instance, extrusion and/or simple stirring into a polymer melt and/or a solvent/polymer mixture.

The organically modified sheet silicates are usually incorporated into the polymer in proportions in the range from 0.001% by weight to 50% by weight, preferably in the range from 1% by weight to 10% by weight.

The present invention further provides for the use of the modified sheet silicates obtained by the process of the invention for incorporation into polymers.

One type of polymer which is particularly sensitive to impurities is polycarbonate. Polycarbonate reacts to impurities in the form of ions in added materials by degradation of the polymer chain length, which generally makes itself known by clouding and/or yellowish/brownish discoloration of the polymer.

Preference is accordingly given to the use of the modified sheet silicates obtained by the process of the invention for incorporation into polycarbonate.

This allows utilization of the increased barrier properties towards gas or chemicals by addition of such modified sheet silicates without having to fear the disadvantage of polymer degradation. In addition, this can be achieved particularly simply by means of the process of the invention.

The present invention therefore further provides a polymer material, preferably polycarbonate material, into which organically modified sheet silicates obtained by the inventive process described here have been incorporated.

The invention is illustrated below with the aid of a FIGURE.

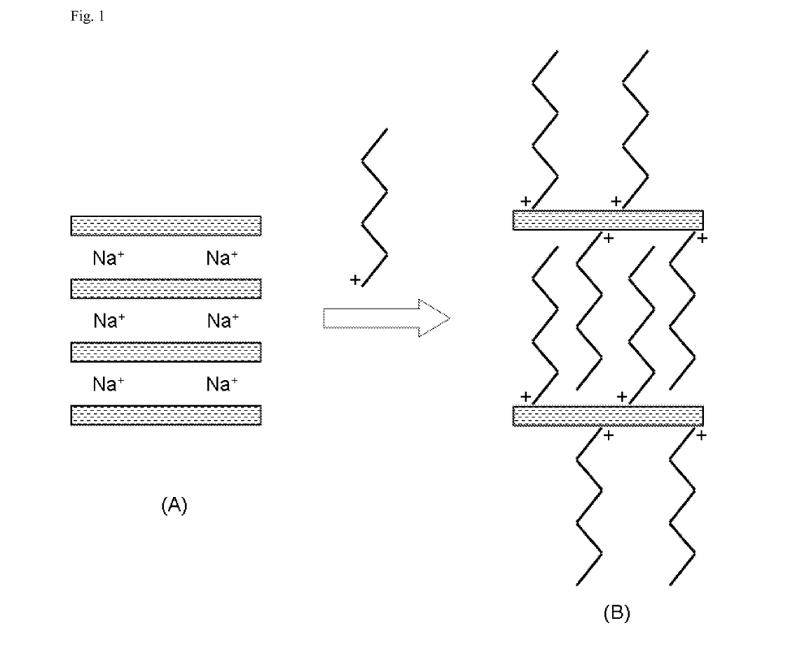

FIG. 1 schematically shows a process according to the invention in which an unmodified sheet silicate (A) in which in this case exclusively sodium ions are present in the intermediate spaces between the respective layers is organically modified using a singly positively charged trimethylalkylammonium. The particles of an ion exchange resin (not shown) lead to the modified sheet silicate (B) in the dispersion being present alone and in particular not in the presence of sodium ions after the particles of the ion exchange resin have been filtered off.

The present invention is illustrated by the following examples, without being restricted thereto.

### EXAMPLES

### Example 1

### Process of the Invention (Purification Immediately After Reaction)

3 kg of a 5% strength dispersion of natural, unmodified montmorillonite sheet silicate (PGV, from Nordmann, Rassmann GmbH) in distilled water were shaken overnight in a shaking bath.

64.5 g of a mixture of stearylaminoethoxylates of the formula (R)((CH₂CH₂O)ₓ)H)((CH₂CH₂O)_{y})H)N where x+y=2 and R=stearyl (Genamin 5020 Spezial, from Clariant; CAS-No. 71786-60-2) were added to 700 ml of distilled water which had been brought to a pH of 2 by stirring with concentrated hydrochloric acid in a three-neck flask and heated to 80° C. by means of a waterbath.

The sheet silicate suspension was added dropwise and the pH was monitored during the addition and if necessary adjusted by means of concentrated hydrochloric acid so that the pH remained at about 3. The mixture was stirred further at 80° C. for three hours. The mixture was subsequently slowly cooled to room temperature while stirring.

The dispersion obtained in this way was separated into a solids fraction and a liquid fraction by filtration through a round filter (from Schleicher & Schuell, type: Whatman 602H) and the moist solids fraction was once again taken up in fresh distilled water.

An ion exchange resin (Lewatit UltraPure 1294 MD, from Lanxess; 1:1 mixture of a basic anion exchange resin and an acidic cation exchange resin) was added while stirring to the redispersed solids fraction while monitoring the conductivity of the dispersion.

The addition was stopped when the conductivity had dropped to a value of about 4 μS/cm. Finally, the ion exchanger was separated off by means of a 400 μm sieve.

### Example 2

### Process of the Invention (Purification During the Reaction)

The process was repeated in a manner analogous to Example 1, but, as the sole difference, the addition of the ion exchange resin to the dispersion was carried out before filtration, i.e. the ion exchange resin was added directly to the reaction solution after modification. The first filtration step was therefore omitted.

### Example 3

### Further Process According to the Invention

The process as per Example 2 was repeated, but, as the sole difference, 340.2 g of a substance having the formula (1) below (Jeffamine® M-2005 amine; from Huntsman)

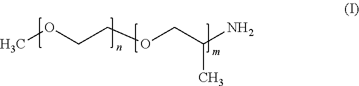

where 4≦n≦8 and 25≦m≦35,
were used instead of 64.5 g of a mixture of bis(2-hydroxyethyl)alkylamine having alkyl radicals in the range from C₁₂ to C₁₈.

### Example 4

### Drying and Introduction of the Modified Sheet Silicates as per Ex. 3 into a Polymer

The sheet silicate which has been modified according to the invention from Example 3 was dried and subsequently extruded together with polycarbonate (Makrolon 1140, from Bayer Material Science AG) so that the concentration of modified sheet silicate in the polymer was 1% by weight.

The material obtained was subsequently checked for molar mass degradation, which is a useful indicator for the compatibility and purity of the sheet silicate material with the polymer, by means of viscosity measurements. If the sheet silicate material were to contain a high proportion of impurities, in particular in the form of sodium ions, the molar mass of the polymer (here polycarbonate, which is particularly sensitive in this regard) would drop significantly compared to its original value after introduction of the sheet silicate material. A measurement method for determining the change in the molar mass of polycarbonate is measurement of the dynamic viscosity before and after treatment of the polycarbonate.

A measurement method for determining the change in the molar mass of polycarbonate is measurement of the dynamic viscosity before and after treatment of the polycarbonate. In this method, the times required for a dissolved polymer to run through an Ubbelohde viscometer are measured in order then to determine the viscosity difference between polymer solution and its solvent. From this, the viscosity number can be determined taking into account the mass concentration of the polymer solution. The viscosity number correlates with the molar mass of a polymer, so that relative values are obtained.

A relative viscosity of 1.312 was obtained, compared to 1.320 for the pure polycarbonate. Accordingly, the introduction of the pure sheet silicate material produced according to the invention has not had a significant adverse effect on the molar mass of the polycarbonate.

In contrast to the prior art, the isolation was simplified in the process of the invention by the use of particles of the ion exchange resin and, in addition, the purification was carried out right in the reaction mixture, which makes the process more efficient. Furthermore, the use of bifunctional ion exchange resins can ensure the freedom of the organically modified sheet silicate from cation residues AND anion residues, which both would otherwise have led to an adverse effect on the product properties after later introduction into a polymer, as in Example 3.

1. A process for preparing an organically modified sheet silicate by dispersing sheet silicate in a solvent comprising at least one organic molecule having at least a single positive charge, wherein particles of a bifunctional ion exchange resin which can exchange anions and cations are also dispersed in said solvent.

2. A process according to claim 1, wherein the solvent is water and/or an ionic liquid.

3. A process according to claim 1, wherein the proportion of sheet silicate in the solvent is in a range from 0.1 to 50% by weight, optionally in a range from 1 to 20% by weight.

4. A process according to claim 1, wherein said process is carried out at a pH of less than or equal to 4.

5. A process according to claim 1, wherein the at least one organic molecule having at least a single positive charge is an organic molecule in which the positive charge is due to at least one quaternary ammonium group or at least one phosphonium group or in which the positive charge is present in a heterocyclic compound.

6. A process according to claim 5, wherein the at least one organic molecule having at least a single positive charge is an organic molecule in which the positive charge is present in a heterocyclic compound in the form of a pyridinium and/or imidazolium ion.

7. A process according to claim 6, wherein the at least one organic molecule having at least a single positive charge is added to the solvent in a CEC ratio in a range from 0.2 to 1.5 meq/g, optionally in a range from 0.5 to 1.2 meq/g.

8. A process according to claim 1, wherein average particle size of the sheet silicate and average particle size of the ion exchange resin differs by a factor of at least 10.

9. A process according to claim 1 wherein the bifunctional ion exchange resin is a mixture of a cation exchange resin and an anion exchange resin.

10. A process claim 1, wherein the bifunctional ion exchange resin is a copolymer comprising blocks having basic and acidic properties.

11. A process according to claim 1, wherein the sheet silicate and the organic molecule having at least a positive charge are provided in separate solution/dispersion, mixed with one another and the bifunctional ion exchange resin is added to the resulting solution/dispersion immediately after mixing and/or during mixing.

12. A process according to claim 1, wherein a drying step follows and is followed by a further step in which an organically modified sheet silicate which has been dried is incorporated into a polymer.
